(19) United States
(12) Patent Application Publication
(10) Pub. No.: US 2015/0293862 A1
(43) Pub. Date: Oct. 15, 2015

(54) HARDWARE CONFIGURATION APPARATUS

(71) Applicant: ANDES TECHNOLOGY CORPORATION, Hsin-Chu City (TW)

(72) Inventor: Chi-Chang Lai, Hsinchu County (TW)

(73) Assignee: ANDES TECHNOLOGY CORPORATION, Hsin-Chu City (TW)

(21) Appl. No.: 14/249,365

(22) Filed: Apr. 10, 2014

(51) Int. Cl. G06F 13/12

(52) U.S. Cl. CPC G06F 13/122

(57) ABSTRACT

A hardware configuration apparatus is provided. The hardware configuration apparatus is a part of a hardware system and the hardware system includes at least one function. The hardware configuration apparatus includes an interface unit, a resolution unit, and an output generation unit. For each function of the hardware system, the resolution unit generates a current setting corresponding to the function based on a default setting corresponding to the function and function settings of a plurality of secure configuration entries (SCEs) corresponding to the function. The interface unit is coupled to the resolution unit and a storage storing the SCEs. The interface unit provides the SCEs to the resolution unit. The output generation unit is coupled to the resolution unit. For each function of the hardware system, the output generation unit outputs a configuration signal to enable or disable the function according to the current setting corresponding to the function.

### BACKGROUND OF THE INVENTION

1. Field of the Invention

The present invention relates to a hardware configuration apparatus. More particularly, the present invention relates to a hardware configuration apparatus of a hardware system.

2. Description of the Related Art

A hardware system could be an integrated circuit (IC) chip, a printed circuit board (PCB) with chips installed, a computer system, or an electronic device. Sometimes a vendor sells multiple models of a hardware system over multiple markets. Each model has a different set of functions. A current trend in manufacturing and marketing of hardware systems is putting all available functions into a single design. For each model, the functions that should not be included in the model are disabled by some mechanism of hardware configuration.

The models of a hardware system are usually distinguished by their functions and prices. Due to the single design, even a low-end model is manufactured with the same functions as those of a high-end model. However, the functions available only in the high-end model are always disabled in the low-end model. Since the low-end model is cheaper, it is inevitable that someone tries to hack the low-end model to enable the high-end functions without paying the high-end price. Therefore, there is the need for a secure hardware configuration mechanism to prevent such attempts.

### SUMMARY OF THE INVENTION

Accordingly, the present invention is directed to a hardware configuration apparatus that provides secure and flexible multi-level hardware configuration for a hardware system.

According to an embodiment of the present invention, a hardware configuration apparatus is provided. The hardware configuration apparatus is a part of a hardware system and the hardware system includes at least one function. The hardware configuration apparatus includes an interface unit, a resolution unit, and an output generation unit. For each function of the hardware system, the resolution unit generates a current setting corresponding to the function based on a default setting corresponding to the function and function settings of a plurality of secure configuration entries (SCEs) corresponding to the function. The interface unit is coupled to the resolution unit and a storage storing the SCEs. The interface unit provides the SCEs to the resolution unit. The output generation unit is coupled to the resolution unit. For each function of the hardware system, the output generation unit outputs a configuration signal to enable or disable the function according to the current setting corresponding to the function.

According to another embodiment of the present invention, a hardware configuration apparatus is provided. The hardware configuration apparatus is a part of a hardware system and the hardware system includes at least one function. The hardware configuration apparatus includes an interface unit, a resolution unit, and an output generation unit. For each function of the hardware system, the resolution unit generates a current setting corresponding to the function based on a default setting corresponding to the function and function settings of one or more SCEs corresponding to the function. Each of the default settings, the function settings and the current settings is in one of at least four function states. The interface unit is coupled to the resolution unit and a storage storing the one or more SCEs. The interface unit provides the one or more SCEs to the resolution unit. The output generation unit is coupled to the resolution unit. For each function of the hardware system, the output generation unit outputs a configuration signal to enable or disable the function according to the current setting corresponding to the function.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a hardware configuration apparatus according to an embodiment of the present invention.

FIG. 2 is a schematic diagram showing an SCE according to an embodiment of the present invention.

FIG. 3 is a flow chart showing a part of the resolution process executed by a hardware configuration apparatus according to an embodiment of the present invention.

FIG. 4 is a schematic diagram showing a hardware configuration apparatus according to another embodiment of the present invention.

FIG. 5 is a schematic diagram showing a hardware configuration apparatus according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

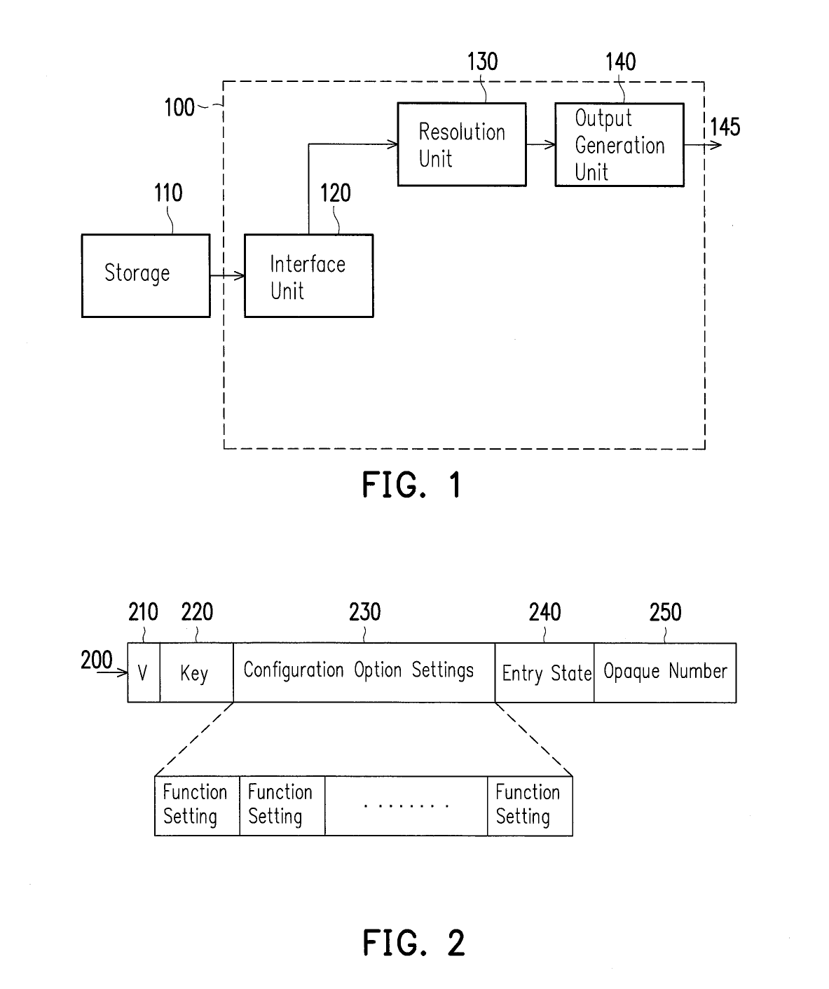

FIG. 1 is a schematic diagram showing a hardware configuration apparatus 100 according to an embodiment of the present invention. The hardware configuration apparatus 100 includes an interface unit 120, a resolution unit 130, and an output generation unit 140. The interface unit 120 is coupled to the storage 110. The resolution unit 130 is coupled to the interface unit 120. The output generation unit 140 is coupled to the resolution unit 130. The interface unit 120, the resolution unit 130, and the output generation unit 140 are all hardware components. The hardware configuration apparatus 100 is a part of a hardware system. The hardware system includes at least one function that can be configured by the hardware configuration apparatus 100.

The storage 110 stores one or more secure configuration entries (SCEs). For example, the storage 110 may be a volatile memory or a non-volatile memory. The interface unit 120 fetches the SCEs from the storage 110 and provides the SCEs to the resolution unit 130. Each SCE includes a plurality of information fields. One of the fields records at least one function setting. Each function setting configures a function of the hardware system. When the resolution unit 130 needs an SCE, the interface unit 120 may provide the entire SCE to the resolution unit 130, or only provide the necessary fields of the SCE to the resolution unit 130.

The resolution unit 130 records a default setting for each function of the hardware system. For each function of the hardware system, the resolution unit 130 generates a current setting corresponding to the function based on the default setting corresponding to the function and the function settings the SCEs corresponding to the function.

For each function of the hardware system, the output generation unit 140 outputs a configuration signal 145 to enable or disable the function according to the current setting corresponding to the function. The output generation unit 140 may provide the configuration signals 145 as direct control signals to the components providing the functions of the hardware system. Alternatively, the output generation unit 140 and the components providing the functions may be connected via a configuration bus and the output generation unit 140 may provide the configuration signals 145 to the components providing the functions in the form of transactions transmitted on the configuration bus.

Although some functions of the hardware system might provide more than two choices of control (such as “disabled” and “enabled”), it is general enough to divide each such function into more functions with just only two choices of control for each function, so that the problem of configuration setting can become a simple binary decision problem.

Each SCE has the same base structure including multiple information fields. For example, FIG. 2 is a schematic diagram showing an SCE 200 according to an embodiment of the present invention. The SCE 200 includes five fields, namely, the valid field 210, the key 220, the configuration option settings 230, the entry state 240, and the opaque number 250.

The valid field 210 may include a valid bit that indicates whether the SCE 200 is valid or invalid. The valid bit is cleared to indicate an invalid SCE when the hardware system is out of factory. The valid bit is set to indicate a valid SCE after at least one field of the SCE 200 is filled with meaningful information by a write access. In another embodiment, the valid field 210 may further include a digest for integrity check in addition to the valid bit. In such an embodiment, the SCE 200 is valid only when the valid bit is set and the SCE 200 passes the integrity check corresponding to the digest.

The configuration option settings 230 include one or more function settings. Each function setting configures a function of the hardware system. The key 220, the entry state 240, and the opaque number 250 are discussed in some following paragraphs. In some embodiments of the present invention, the functions corresponding to the entry state 240 and/or the opaque number 250 do not have to be implemented. Therefore, in those embodiments, the entry state 240 and/or the opaque number 250 may be omitted.

There are many vendors in an industry chain. For example, the aforementioned hardware system may be a chip and there may be a vendor of the chip, a vendor of a motherboard based on the chip, and a vendor of a computer based on the motherboard. The motherboard vendor is downstream to the chip vendor and the computer vendor is downstream to the motherboard vendor. The SCEs are arranged as an array. Each vendor has different privileges for editing the SCEs. For example, the chip vendor may be privileged to edit the first three SCEs, the motherboard vendor may be privileged to edit the next two SCEs, and the computer vendor may be privileged to edit the next one SCE. Each vendor has some control over the SCEs of its downstream vendors through different priority levels of the SCEs. The final configuration of each function of the hardware system is the result of resolution of the function settings of all valid SCEs. Consequently, an embodiment of the present invention may provide a simple mechanism of multi-level hardware configuration. Each level is represented by the one or more SCEs of one vendor. The details of the multi-level configuration mechanism are discussed in some following paragraphs.

The following is the discussion of how the resolution unit 130 generates the current setting corresponding to each function of the hardware system as the result of the resolution of the SCEs. Each function setting of each SCE is in one of at least four function states. The default setting of each function of the hardware system is also in one of the at least four function states. The current setting of each function of the hardware system is also in one of the at least four function states. The function states includes a Never state, a Conditional state, an Ever state, and an Undetermined state. The precedence of the four function states is set as: Never->Conditional->Ever->Undetermined. The most precedent function state is Never and the least precedent function state is Undetermined. The default setting for each function of the hardware system may be any one function state, such as Undetermined.

For each function of the hardware system, the current setting corresponding to the function is the most precedent function state of the function states of the default setting corresponding to the function and the function settings of all valid SCEs corresponding to the function. Sometimes not all SCEs include function settings of exactly the same functions. For each function of the hardware system, when a valid SCE does not include a function setting corresponding to the function, the resolution unit 130 regards the function setting corresponding to the function of that valid SCE to be the default setting corresponding to the function for the generation of the current setting corresponding to the function.

For each function of the hardware system, the resolution unit 130 has to combine the function state of the default setting corresponding to the function and the function states of the function settings of all valid SCEs corresponding to the function to generate the current setting corresponding to the function. When there is no valid SCE, the current setting corresponding to each function is simply the default setting corresponding to the function.

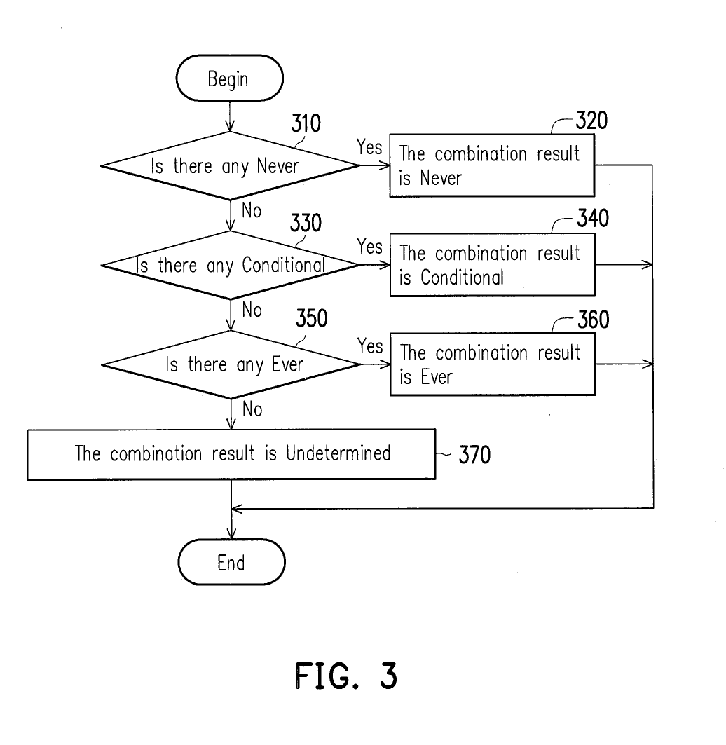

FIG. 3 is a flow chart showing the combination of function states executed by the resolution unit 130 for each function of the hardware system according to an embodiment of the present invention. The resolution unit 130 checks whether there is any Never state in the function states that need to be combined, namely, the function states of the default setting and the function settings of all valid SCEs corresponding to the function (step 310). When there is at least one Never state in the function states that need to be combined, the combination result is the Never state (step 320). When there is no Never state in the function states that need to be combined, the resolution unit 130 checks whether there is any Conditional state in the function states that need to be combined (step 330). When there is at least one Conditional state in the function states that need to be combined, the combination result is the Conditional state (step 340). When there is no Conditional state in the function states that need to be combined, the resolution unit 130 checks whether there is any Ever state in the function states that need to be combined (step 350). When there is at least one Ever state in the function states that need to be combined, the combination result is the Ever state (step 360). When there is no Ever state in the function states that need to be combined, the combination result is the Undetermined state (step 370). An Undetermined state means leaving the configuration of the corresponding function to be determined by other valid SCEs.

When the flow in FIG. 3 ends, the combination results becomes the current settings corresponding to the functions and the resolution unit 130 outputs the current settings of the functions to the output generation unit 140. The hardware of the resolution unit 130 can be small and simple because of the easy process of function state combination.

The output generation unit 140 generates a configuration signal 145 for each function of the hardware system that is configurable by the SCEs. The configuration signal 145 is in one of two signal states, namely, an asserted state and a de-asserted state. The configuration signal 145 enables the corresponding function when the configuration signal 145 is in the asserted state. The configuration signal 145 disables the corresponding function when the configuration signal 145 is in the de-asserted state.

For each function of the hardware system, the output generation unit 140 determines whether the configuration signal 145 corresponding to the function is asserted or de-asserted according to the current setting corresponding to the function. The criterion of the determination is based on best security consideration for the hardware system. The more precedent the current setting of a function is among all of the function states, the more secure the configuration caused by the corresponding configuration signal should be.

The hardware system is more secure when some of its functions are disabled. For example, an access port for external data access is more secure for the hardware system when the access port is disabled and is less secure for the hardware system when the access port is enabled. For such a function, the following Table 1 lists the mapping between the function state of the current setting corresponding to the function and the configuration of the function.

TABLE 1

| Function State | Configuration |
|---|---|
| Never | To disable the function |
| Conditional | To enable the function conditionally |
| Ever | To enable the function |
| Undetermined | To disable the function |

According to Table 1, the configuration signal 145 corresponding to a function is de-asserted when the current setting corresponding to the function is in the Never state or the Undetermined state. The configuration signal 145 corresponding to a function is de-asserted when the current setting corresponding to the function is in the Conditional state and a runtime condition of the hardware system corresponding to the function is false. The configuration signal 145 corresponding to a function is asserted when the current setting corresponding to the function is in the Conditional state and the runtime condition of the hardware system corresponding to the function is true. The configuration signal 145 corresponding to a function is asserted when the current setting corresponding to the function is in the Ever state.

The following is an example of the aforementioned runtime condition. In this example the hardware system is a processor or a computer system capable of executing instructions. Each instruction has an associated security privilege level (SPL). Some functions of the hardware system are reserved for instructions with higher SPLs. Therefore, the runtime condition corresponding to such a reserved function may be whether the SPL of the instruction that is currently executed reaches a preset threshold or not.

The following is another example of the aforementioned runtime condition. In this example the hardware system is a processor or a computer system capable of executing instructions and virtual machines. Some functions of the hardware system are reserved for a specific virtual machine. Therefore, the runtime condition corresponding to such a reserved function may be whether the specific virtual machine is currently executed or not.

Depending on implementation of the hardware system, the runtime condition may be defined differently. Some embodiments of the present invention may specify a runtime condition globally for all functions, while some embodiments may specify a runtime condition independently for each function.

The hardware system is more secure when some of its functions are enabled. For example, a security monitoring function that monitors activities and information exchanges in the hardware system to provide notification signals for security violation is better enabled for security consideration. For such a function, the following Table 2 lists the mapping between the function state of the current setting corresponding to the function and the configuration of the function.

TABLE 2

| Function State | Configuration |
|---|---|
| Never | To enable the function |
| Conditional | To disable the function conditionally |
| Ever | To disable the function |
| Undetermined | To enable the function |

According to Table 2, the configuration signal 145 corresponding to a function is asserted when the current setting corresponding to the function is in the Never state or the Undetermined state. The configuration signal 145 corresponding to a function is asserted when the current setting corresponding to the function is in the Conditional state and a runtime condition of the hardware system corresponding to the function is false. The configuration signal 145 corresponding to a function is de-asserted when the current setting corresponding to the function is in the Conditional state and the runtime condition of the hardware system corresponding to the function is true. The configuration signal 145 corresponding to a function is de-asserted when the current setting corresponding to the function is in the Ever state.

In summary, for each function of the hardware system, one signal state (asserted or de-asserted) of the corresponding configuration signal 145 is more secure for the hardware system and the other signal state (de-asserted or asserted) of the corresponding configuration signal 145 is less secure for the hardware system. The output generation unit 140 outputs the configuration signal 145 in the more secure signal state when the current setting corresponding to the function is in the Never state or the Undetermined state. The output generation unit 140 outputs the configuration signal 145 in the more secure signal state when the current setting corresponding to the function is in the Conditional state and the runtime condition corresponding to the function is false. The output generation unit 140 outputs the configuration signal 145 in the less secure signal state when the current setting corresponding to the function is in the Conditional state and the runtime condition is true. The output generation unit 140 outputs the configuration signal 145 in the less secure signal state when the current setting corresponding to the function is in the Ever state.

The operation of the hardware system begins at power on, followed by a hardware reset of the functions to be configured according to the SCEs. The time of the hardware configuration apparatus 100 applying the function settings of the SCEs may be before the de-assertion of the hardware reset of the functions, immediately after the de-assertion of the hardware reset of the functions, or at runtime of the functions. Here the applying of the function settings of the SCEs includes the resolution unit 130 fetching the SCEs and generating the current settings of the functions of the hardware system and the output generation unit 140 generating the configuration signals 145 to configure the hardware system according to the current settings of the functions.

In an embodiment of the present invention, the hardware configuration apparatus 100 applies the function settings of the SCEs before the de-assertion of the hardware reset of the functions. The SCEs are pre-programmed into the storage 110. The hardware configuration apparatus 100 applies the function settings of the SCEs before the de-assertion of the main system reset signal of the hardware system, so that the functions are reset and configured during the hardware reset of the functions. After the hardware reset of the functions, the related hardware components of the hardware system can see desired configuration settings upon their initialization.

In another embodiment of the present invention, the hardware configuration apparatus 100 applies the function settings of the SCEs immediately after the de-assertion of the hardware reset of the functions. This kind of configuration applying happens right after the de-assertion of the main system reset signal of the hardware system and is completed before any regular function of the hardware system runs.

In another embodiment of the present invention, the hardware configuration apparatus 100 applies the function settings of the SCEs at runtime. Such applying of configuration is conducted without going through the hardware reset of the functions. A software reset may be applied to a function configured in this way. Such applying of configuration may be conducted whenever it is necessary. For example, the hardware configuration apparatus 100 may apply the function settings of the SCEs when the hardware system switches from a virtual machine to another virtual machine. Another example is that the hardware configuration apparatus 100 may apply the function settings of the SCEs after one or more fields of the SCEs are updated at runtime.

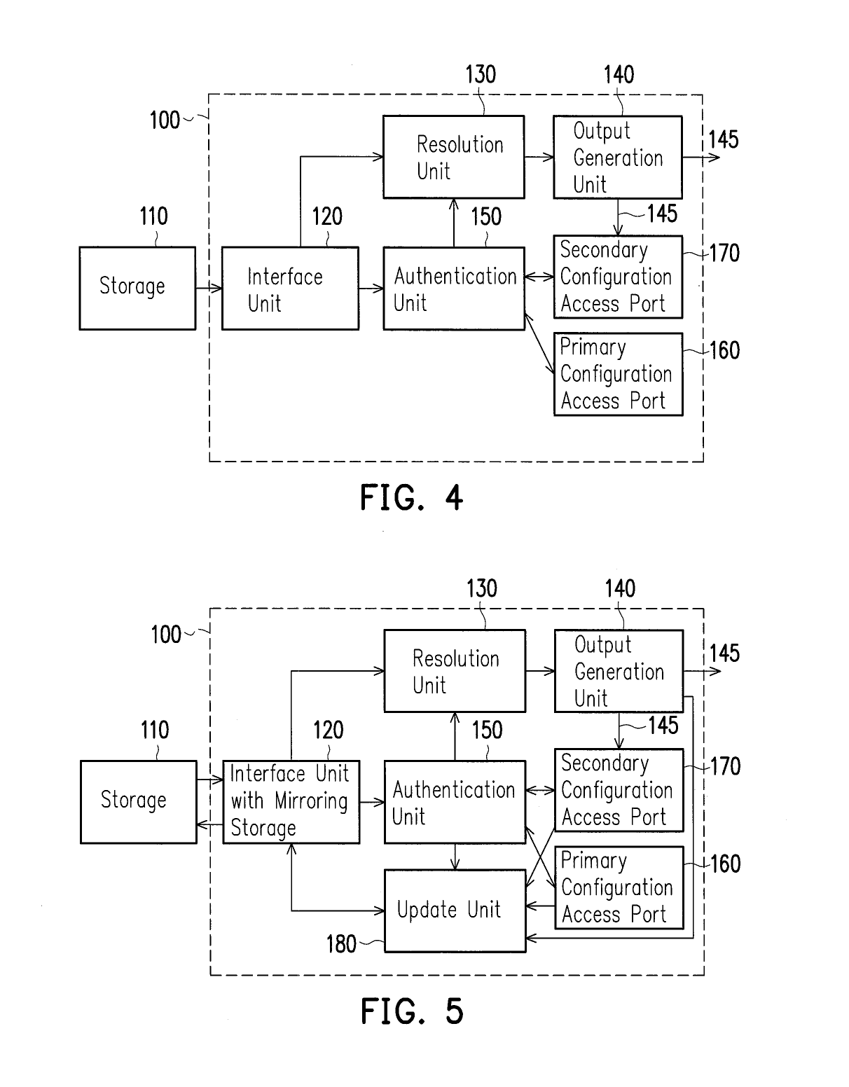

FIG. 4 is a schematic diagram showing a hardware configuration apparatus 100 according to another embodiment of the present invention. The hardware configuration apparatus 100 in this embodiment further includes an authentication unit 150, a primary configuration access port (PCAP) 160, and at least one secondary configuration access port (SCAP) 170. The authentication port 150 is coupled to the interface unit 120 and the resolution unit 130. The PCAP 160 is coupled to the authentication unit 150. The SCAP 170 is coupled to the output generation unit 140 and the authentication unit 150. The authentication unit 150, the PCAP 160, and the SCAP 170 are all hardware components.

The PCAP 160 is dedicated to the initial programming of the SCEs in the storage 110 when the hardware system is manufactured in the production line. In runtime the PCAP 160 is invisible and inaccessible to both the software and the hardware of the hardware system. The SCAP 170 is for runtime access to the SCEs. A master of the hardware configuration apparatus 100 may access the SCEs through the PCAP 160 or the SCAP 170. Here the term “master” means a piece of software or hardware inside the hardware system or outside the hardware system. There are three types of access to the SCEs, namely, authentication access, read access, and write access. The authentication unit 150 in the embodiments of FIG. 4 and FIG. 5 handles the authentication accesses and the read accesses. The update unit 180 in the embodiment of FIG. 5 handles the write accesses after the write accesses are authenticated by the authentication unit 150.

In an embodiment of the present invention, no SCAP is implemented in the hardware configuration apparatus 100. Therefore, all external accesses to the SCEs go through the PCAP 160.

When there is one or more SCAPs 170 implemented in the hardware configuration apparatus 100, accessibility of the one or more SCAPs 170 in the hardware system may be controlled by one or more function settings in the SCEs. In other words, the one or more SCAPs 170 may belong to the configurable functions of the hardware system that can be enabled or disabled. Therefore, the output generation unit 140 outputs at least one corresponding configuration signal 145 to the one or more SCAPs 170.

The SCEs are arranged as an array. In an embodiment of the present invention, the first N SCEs are reserved for the most upstream vendor of the hardware system. N may be zero or a preset positive integer. In such an embodiment, the authentication unit 150 may limit the SCAP 170 to the other SCEs only. In other words, accesses to the first N SCEs must go through the PCAP 160, while accesses to the other SCEs may go through the PCAP 160 or the SCAP 170.

As mentioned above, the SCEs are arranged as an array, so that each SCE is associated with an implicit index in the array. Before accessing an SCE, a master has to specify which SCE it wants to access. There are three ways to specify an SCE. The simplest way to specify an SCE is providing its implicit index to the authentication unit 150.

However, an SCE is prone to hacking when the SCE has a fixed index. So it is better to use an opaque number as index to access the SCE array, which is the second way to specify an SCE. In an embodiment of the present invention, each SCE includes an opaque number 250. The rightful vendor of an SCE knows its opaque number. The opaque number is preferably a random number, so that other persons or vendors cannot guess the opaque number and thus cannot access that SCE.

In an embodiment wherein the opaque number is implemented, a master sends a request and an opaque number to the authentication unit 150 through the PCAP 160 or the SCAP 170 when the master wants to access an SCE. The authentication unit 150 receives the request and the opaque number. The authentication unit 150 associates the request to a valid SCE whose opaque number matches the received opaque number. The authentication unit 150 rejects the request when there is no valid SCE whose opaque number matches the received opaque number.

Most read accesses and write accesses need to be authenticated first. The authentication is conducted by the authentication unit 150 after a master specifies an SCE successfully. When a master fails to specify an SCE, the authentication unit 150 rejects the request and authentication is unnecessary. Authentication is conducted only against valid SCEs.

The typical process of authentication is for the master to send a request through the PCAP 160 or the SCAP 170 to specify an SCE to be authenticated, and provide a challenge string to be verified with the key 220 in the SCE. The authentication unit 150 receives the challenge string through the PCAP 160 or the SCAP 170 and conducts an authentication by verifying the challenge string with the key of the requested SCE. The authentication unit 150 regards the requested SCE as an authenticated SCE when the authentication passes. The authentication unit 150 rejects the request to access the SCE when the authentication fails. When the authentication fails, the authentication unit 150 may perform some direct response to the failure, such as halting or resetting the hardware system.

Some embodiments of the present invention do not implement the entry state fields 240 in the SCEs. In those embodiments, the hardware configuration apparatus 100 has no memory of authentication failure. On the other hand, some embodiments of the present invention implement the entry state fields 240 in the SCEs. In those embodiments, an SCE may become locked when its number of authentication failures reaches a predetermined threshold value.

In an embodiment of the present invention, each SCE includes an entry state 240. The entry state is unlocked initially. Each time when the authentication for an SCE fails, the authentication unit 150 increases the number of authentication failures of the SCE by one. The number of authentication failures may be encoded as part of the entry state field. Alternatively, the number of authentication failures of the SCE may be in independent field of the SCE. The number of authentication failures is stored with the SCE in the storage 110 so that the number can be preserved when the power of the hardware system is turned off.

The authentication unit 150 switches the entry state of the SCE from unlocked to locked when the number of authentication failures of the SCE reaches a predetermined threshold value. Before reaching the threshold, the entry state remains in the unlocked state and the authentication result is determined as usual. When the entry state of an SCE is in the locked state, the authentication unit 150 regards any authentication conducted for the SCE as a failure and the entry state of the SCE remains unchanged.

When the resolution unit 130 generates the current settings of the functions of the hardware system, the resolution unit 130 checks the entry state of each valid SCE. When the entry state of any valid SCE is locked, the resolution unit 130 terminates the combination process shown in FIG. 3 and sets the current setting corresponding to each function of the hardware system to be the default setting corresponding to the function. In this embodiment, the default setting for each function is in the Undetermined state, that means the configuration signal 145 corresponding to each function is in the more secure state (asserted or de-asserted) for the hardware system.

In an embodiment of the present invention, the entry state of an SCE may be set to be in a non-lockable state initially. When the entry state of an SCE is non-lockable, the hardware configuration apparatus 100 has no memory of authentication failure for that SCE. That SCE is never locked no matter how many times its authentication fails.

By default, the resolution unit 130 generates the current settings corresponding to the functions of the hardware system based on the function settings of all valid SCEs. In an embodiment of the present invention, a master may confine the generation of the current settings to a subset of the valid SCEs in the runtime of the hardware system by specifying an SCE and sending a request for authentication for the SCE to the authentication unit 150. After the authentication passes, the authentication unit 150 informs the resolution unit 130 of the authenticated SCE. Next, for each function of the hardware system, the resolution unit 130 generates the current setting corresponding to the function by combining the default setting corresponding to the function with the function settings corresponding to the function of the valid SCEs from the first SCE to the authenticated SCE. That is, the authenticated SCE becomes the last SCE of the runtime confinement.

Once a master passes the aforementioned authentication process for an SCE, the authentication unit 150 may allow the master to access the authenticated SCE, invalid SCEs, or even other valid SCEs. In some embodiments of the present invention, the key field 220 of each SCE includes only one key. The authentication for runtime confinements, read accesses and write accesses use the same key. In some other embodiments of the present invention, the key field 220 of each SCE may include two keys. One key is used in the authentication for runtime confinements, while the other key is used in the authentication for read accesses and write accesses.

When a master sends a request for read access to an SCE to the authentication unit 150 and the authentication for the SCE passes, the authentication unit 150 may allow the master to read a part of the authenticated SCE, such as the configuration option settings 230, the entry state 240, and the opaque number 250 of the SCE. For security consideration, the key field 220 should not be readable in any case. When the master fails to specify the SCE or fails to authenticate against the SCE, the authentication unit 150 rejects the request.

FIG. 5 is a schematic diagram showing a hardware configuration apparatus 100 according to another embodiment of the present invention. The hardware configuration apparatus 100 in this embodiment further includes an update unit 180 coupled to the interface unit 120, the output generation unit 140, the authentication unit 150, the PCAP 160, and the SCAP 170. The update unit 180 handles the part of writing data into the SCEs of the write accesses.

In addition, the interface unit 120 in this embodiment may include a mirroring storage that is a volatile storage when the storage 110 is a non-volatile storage. The mirroring storage operates as a cache used to keep a runtime copy of the SCEs for faster access, since a volatile storage is usually faster than a non-volatile storage is. Both of the update unit 180 and the mirroring storage are hardware components.

The authentication unit 150 in this embodiment can handle both read accesses and write accesses to the SCEs. The read accesses are handled in the same way as that in the embodiment of FIG. 4. After a master sends a request for write access to an SCE to the authentication unit 150 and the authentication for the SCE passes, the authentication unit 150 may allow the master to conduct write access to a part of the authenticated SCE, such as writing to the configuration option settings 230 and the opaque number 250 of the authenticated SCE. The authentication unit 150 rejects the write access when the authentication fails.

The SCEs have different priorities. In an embodiment of the present invention, the SCEs are arranged as an array according to descending order of priority. In other words, the first SCE has the highest priority and the last SCE has the lowest priority. After the authentication requested by a master for an SCE passes, the authentication unit 150 may allow the master to access a valid SCE whose priority is lower than that of the authenticated SCE. For security concern, the authentication unit 150 limits the access to invalidating the valid SCE by clearing its valid bit or switching the entry state of the valid SCE from locked to unlocked only. The number of authentication failures is reset when the entry state of the valid SCE is switched to the unlocked state. Therefore, when an SCE is locked, only a successful authentication against another SCE with higher priority can invalidate or unlock the locked SCE.

After the authentication requested by a master for an SCE passes, the authentication unit 150 may allow the master to conduct write access to any invalid SCE. The entire invalid SCE may be written with new values by the master, unless some current setting based on valid SCEs disables this accessibility. The authentication unit 150 rejects the write access when the authentication fails.

As a cache, the mirroring storage in the interface unit 120 may be used as a cumulating place to collect complete SCE contents with recent changes, before the update unit 180 permanently updates the changes into the storage 110. In an embodiment of the present invention, the authentication unit 150 may allow a master to conduct write access to an SCE in the mirroring storage only, according to some current setting based on valid SCEs. Since the mirroring storage is volatile, the changes made by such write access is temporary and are discarded when the power of the hardware system is turned off.

In summary, the present invention provides a configuration mechanism for a hardware system based on one or more SCEs. A more upstream vendor of the hardware system may program the key fields of some invalid SCEs in advance and distribute corresponding keys to downstream vendors of the hardware system for the authentication against the SCEs. The most upstream vendor can control which vendor can access which SCEs by determining which key is given to which vendor. Each vendor can access one or more SCEs. In addition, a vendor who can access a high-priority SCE has some control over lower-priority SCEs. Although the final result of the configuration of the functions of the hardware system is determined by all of the SCEs, the vendors can configure the functions of their hardware systems independently according to their priority levels in the SCEs. The accessibility to the function settings of the SCEs is secure due to the way the SCEs are specified and the way the masters are authenticated. Therefore, the present invention provides a secure multi-level configuration mechanism for the hardware system, which is capable of providing control and flexibility of hardware configuration to the vendors, and is capable of protecting the value and integrity of the hardware system. Besides, the resolution unit of the hardware configuration apparatus can be small and cheap because the process of function states combination is simple.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hardware configuration apparatus of a hardware system comprising at least one function, the hardware configuration apparatus comprising:
a resolution unit, for each said function of the hardware system the resolution unit generating a current setting corresponding to the function based on a default setting corresponding to the function and function settings of a plurality of secure configuration entries (SCEs) corresponding to the function;
an interface unit coupled to the resolution unit and a first storage storing the SCEs, the interface unit providing the SCEs to the resolution unit; and
an output generation unit coupled to the resolution unit, for each said function of the hardware system the output generation unit outputting a configuration signal to enable or disable the function according to the current setting corresponding to the function.

2. The hardware configuration apparatus of claim 1, wherein each of the default settings, the function settings and the current settings is in one of at least four function states.

3. The hardware configuration apparatus of claim 2, wherein for each said function of the hardware system, the current setting corresponding to the function is a most precedent function state of the function states of the default setting and the function settings of valid ones of the SCEs corresponding to the function.

4. The hardware configuration apparatus of claim 3, wherein for each said function of the hardware system, when a valid one of the SCEs does not comprise a function setting corresponding to the function, the resolution unit regards the function setting to be the default setting corresponding to the function for the generation of the current setting.

5. The hardware configuration apparatus of claim 3, wherein in order of decreasing precedence, the function states comprise a first state, a second state, a third state and a fourth state, wherein for each said function of the hardware system,
the configuration signal is in one of two signal states comprising an asserted state and a de-asserted state, the configuration signal enables the function when the configuration signal is in the asserted state and the configuration signal disables the function when the configuration signal is in the de-asserted state, one of the signal states is more secure for the hardware system and the other one of the signal states is less secure for the hardware system,
the output generation unit outputs the configuration signal in the more secure signal state when the current setting corresponding to the function is in the first state or the fourth state,
the output generation unit outputs the configuration signal in the more secure signal state when the current setting corresponding to the function is in the second state and a runtime condition of the hardware system corresponding to the function is false,
the output generation unit outputs the configuration signal in the less secure signal state when the current setting corresponding to the function is in the second state and the runtime condition is true,
the output generation unit outputs the configuration signal in the less secure signal state when the current setting corresponding to the function is in the third state.

6. The hardware configuration apparatus of claim 1, wherein each said SCE comprises an opaque number, the hardware configuration apparatus further comprising:
an authentication unit coupled to the interface unit and the resolution unit, receiving a request for a said SCE and an opaque number, the authentication unit associating the request to one valid said SCE whose opaque number matches the received opaque number, the authentication unit rejecting the request when there is no valid SCE whose opaque number matches the received opaque number.

7. The hardware configuration apparatus of claim 1, wherein each said SCE comprises a key, the hardware configuration apparatus further comprising:
an authentication unit coupled to the interface unit and the resolution unit, receiving a request for a said SCE and a challenge string from a master, wherein the master is a piece of software or hardware inside the hardware system or outside the hardware system, the authentication unit conducting an authentication by verifying the challenge string with the key of the requested SCE, the authentication unit regarding the requested SCE as an authenticated SCE when the authentication passes, and the authentication unit rejecting the request when the authentication fails.

8. The hardware configuration apparatus of claim 7, wherein for each said function of the hardware system the resolution unit generates the current setting corresponding to the function based on the function settings corresponding to the function of the SCEs from the first SCE to the authenticated SCE.

9. The hardware configuration apparatus of claim 7, wherein the authentication unit allows the master to conduct read access to a part of the authenticated SCE.

10. The hardware configuration apparatus of claim 7, wherein the authentication unit allows the master to conduct write access to any invalid one of the SCEs after the authentication passes.

11. The hardware configuration apparatus of claim 7, wherein each said SCE comprises an entry state, the authentication unit switches the entry state of a said SCE from unlocked to locked when a number of authentication failures of the SCE reaches a predetermined threshold value, and the authentication unit regards any authentication conducted for a said SCE whose entry state is locked as a failure.

12. The hardware configuration apparatus of claim 11, wherein when the entry state of any valid one of the SCEs is locked, the resolution unit sets the current setting corresponding to each said function of the hardware system to be the default setting corresponding to the function.

13. The hardware configuration apparatus of claim 11, wherein the authentication unit allows the master to conduct write access to a part of the authenticated SCE.

14. The hardware configuration apparatus of claim 11, wherein the authentication unit allows the master to access a valid one of the SCEs whose priority is lower than that of the authenticated SCE, and the access is limited to invalidating the valid SCE or switching the entry state of the valid SCE from locked to unlocked.

15. The hardware configuration apparatus of claim 7, wherein the interface unit comprises a second storage operating as a cache for the SCEs stored in the first storage, and the authentication unit allows the master to conduct write access to at least one said SCE in the second storage only.

16. A hardware configuration apparatus of a hardware system comprising at least one function, the hardware configuration apparatus comprising:
a resolution unit, for each said function of the hardware system the resolution unit generating a current setting corresponding to the function based on a default setting corresponding to the function and function settings of one or more secure configuration entries (SCEs) corresponding to the function, each of the default settings, the function settings and the current settings being in one of at least four function states;
an interface unit coupled to the resolution unit and a storage storing the one or more SCEs, the interface unit providing the one or more SCEs to the resolution unit; and
an output generation unit coupled to the resolution unit, for each said function of the hardware system the output generation unit outputting a configuration signal to enable or disable the function according to the current setting corresponding to the function.

17. The hardware configuration apparatus of claim 16, wherein for each said function of the hardware system, the current setting corresponding to the function is a most precedent function state of the function states of the default setting and the function settings of valid ones of the SCEs corresponding to the function.

18. The hardware configuration apparatus of claim 17, wherein in order of decreasing precedence, the function states comprise a first state, a second state, a third state and a fourth state, wherein for each said function of the hardware system,
the configuration signal is in one of two signal states comprising an asserted state and a de-asserted state, the configuration signal enables the function when the configuration signal is in the asserted state and the configuration signal disables the function when the configuration signal is in the de-asserted state, one of the signal states is more secure for the hardware system and the other one of the signal states is less secure for the hardware system,
the output generation unit outputs the configuration signal in the more secure signal state when the current setting corresponding to the function is in the first state or the fourth state,
the output generation unit outputs the configuration signal in the more secure signal state when the current setting corresponding to the function is in the second state and a runtime condition of the hardware system corresponding to the function is false,
the output generation unit outputs the configuration signal in the less secure signal state when the current setting corresponding to the function is in the second state and the runtime condition is true,
the output generation unit outputs the configuration signal in the less secure signal state when the current setting corresponding to the function is in the third state.

19. The hardware configuration apparatus of claim 16, wherein each said SCE comprises an opaque number, the hardware configuration apparatus further comprising:
an authentication unit coupled to the interface unit and the resolution unit, receiving a request for a said SCE and an opaque number, the authentication unit associating the request to one valid said SCE whose opaque number matches the received opaque number, the authentication unit rejecting the request when there is no valid SCE whose opaque number matches the received opaque number.

20. The hardware configuration apparatus of claim 16, wherein each said SCE comprises a key, the hardware configuration apparatus further comprising:
an authentication unit coupled to the interface unit and the resolution unit, receiving a request for a said SCE and a challenge string from a master, wherein the master is a piece of software or hardware inside the hardware system or outside the hardware system, the authentication unit conducting an authentication by verifying the challenge string with the key of the requested SCE, the authentication unit regarding the requested SCE as an authenticated SCE when the authentication passes, and the authentication unit rejecting the request when the authentication fails.

21. The hardware configuration apparatus of claim 20, wherein for each said function of the hardware system the resolution unit generates the current setting corresponding to the function based on the function settings corresponding to the function of the SCEs from the first SCE to the authenticated SCE.

22. The hardware configuration apparatus of claim 20, wherein the authentication unit allows the master to conduct read access to a part of the authenticated SCE.

23. The hardware configuration apparatus of claim 20, wherein each said SCE comprises an entry state, the authentication unit switches the entry state of a said SCE from unlocked to locked when a number of authentication failures of the SCE reaches a predetermined threshold value, and the authentication unit regards any authentication conducted for a said SCE whose entry state is locked as a failure.

24. The hardware configuration apparatus of claim 23, wherein when the entry state of any valid one of the one or more SCEs is locked, the resolution unit sets the current setting corresponding to each said function of the hardware system to be the default setting corresponding to the function.

25. The hardware configuration apparatus of claim 23, wherein the authentication unit allows the master to conduct write access to a part of the authenticated SCE.

26. The hardware configuration apparatus of claim 23, wherein the authentication unit allows the master to access a valid one of the one or more SCEs whose priority is lower than that of the authenticated SCE, and the access is limited to invalidating the valid SCE or switching the entry state of the valid SCE from locked to unlocked.
